(19) United States
(12) Patent Application Publication
(10) Pub. No.: US 2026/0371367 A1
(43) Pub. Date: Nov. 19, 2026

(54) USER EQUIPMENT AND METHOD OF RESOURCE ALLOCATION IN SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/734,437

(22) Filed: Jul. 8, 2026

Related U.S. Application Data
(63) Continuation of application No. PCT/CN2024/074025, filed on Jan. 25, 2024.

(51) Int. Cl. H04W 72/25; H04B 7/06; H04W 72/0446

(52) U.S. Cl. CPC H04W 72/25; H04B 7/06952; H04W 72/0446

(57) ABSTRACT

A method of resource allocation in sidelink (SL) communication by a user equipment (UE) is provided. The method includes that: at least one slot is allocated for at least one SL communication cast type within at least one resource pool; and a transmit (TX) beam is applied to transmit a SL transport block (TB), or a receive (RX) beam is applied to receive the SL TB when the UE operates in the at least one slot for the at least one SL communication cast type.

### CROSS-REFERENCE TO RELATED APPLICATION

This is a continuation application of International Patent Application No. PCT/CN2024/074025, filed on Jan. 25, 2024, entitled “USER EQUIPMENT AND METHOD OF RESOURCE ALLOCATION IN SIDELINK COMMUNICATION”, the disclosure of which is hereby incorporated by reference in its entirety.

### BACKGROUND OF DISCLOSURE

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in the area of device power saving and transceiver link reliability. In Release 18, 3GPP further evolved the wireless technology and expanded its operation into unlicensed frequency spectrum. This is for larger available bandwidth, faster data transfer rate, and easier market adoption of D2D communication using sidelink without requiring any mobile cellular operator's involvement to allocate and configure a part of their expansive precious radio spectrum for data services that do not go throughput their mobile networks. For future releases of sidelink technology, one potential and promising technical feature is to support sidelink communication with simultaneous transmission (TX) and reception (RX) on multiple carriers and/or resource pools to further enhance the throughput data rate (via carrier aggregation, CA), in an assistance manner (one carrier assisting another carrier) and repeating data packets on multiple carriers to further enhance communication reliability (via packet duplication).

For the NR sidelink system, it is claimed to support frequency range 2 (FR2) spectrum bands (24250 MHz-71000 MHz) by introducing a phase tracking reference signal (PT-RS) in Release 16. However, no particular enhancement or advanced feature has been supported in NR sidelink to combat/mitigate the high pathloss issue in FR2. In addition, if a beamforming feature is to be introduced in sidelink communication, a beam direction in which a channel sensing is performed remains unclear. This would have a significant impact to results of the channel sensing, obtained resource reservation information, and a reception performance of sidelink data.

Therefore, there is a need for a user equipment (UE) and a method of resource allocation in sidelink (SL) communication, which can solve issues in the prior art and other issues.

### SUMMARY

The present disclosure relates to the field of communication systems, and more particularly, to a user equipment (UE) and a method of resource allocation in sidelink (SL) communication, and a non-transitory machine-readable storage medium.

In a first aspect of the present disclosure, a method of resource allocation in sidelink (SL) communication by a user equipment (UE) includes allocating at least one slot for at least one SL communication cast type within at least one resource pool and applying a transmit (TX) beam to transmit or a receive (RX) beam to receive a SL transport block (TB) when the UE operates in the at least one slot for the at least one SL communication cast type.

In a second aspect of the present disclosure, a user equipment (UE) includes a memory, a transceiver, and a processor coupled to the memory and the transceiver. The processor is configured to cause the UE to: allocate at least one slot for at least one sidelink (SL) communication cast type within at least one resource pool; and apply a transmit (TX) beam to transmit or a receive (RX) beam to receive a SL transport block (TB) when the UE operates in the at least one slot for the at least one SL communication cast type.

In a third aspect of the present disclosure, a non-transitory machine-readable storage medium has stored thereon instructions that, when executed by a computer, cause the computer to: allocate at least one slot for at least one sidelink (SL) communication cast type within at least one resource pool; and apply a transmit (TX) beam to transmit or a receive (RX) beam to receive a SL transport block (TB) when the UE operates in the at least one slot for the at least one SL communication cast type.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method of resource allocation in sidelink (SL) communication according to an embodiment of the present disclosure.

FIG. 5 is a schematic diagram illustrating proposed SL resource separation/partitioning at a resource pool level for different SL communication cast types according to an embodiment of the present disclosure.

FIG. 6 is a schematic diagram illustrating a proposed SL resource separation/partitioning at a slot level for SL unicast communication within a resource pool according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In 3GPP Release 16, the sidelink technology has been developed based on the latest 5th generation (5G) new radio (NR) access system including the support of frequency range 1 (FR1) bands (410 MHz-7125 MHz), frequency range 2 (FR2) bands (24250 MHz-71000 MHz), and various orthogonal frequency division multiplexing signal (OFDM) transmission numerologies/sub-carrier spacings (SCSs) (15 k, 30 k, 60 k, and 120 k Hz). One of the main motivations to support additional spectrum bands compared to a 4G long term evolution (LTE) system (i.e., FR2) is the availability of large spectral bandwidth to support high data rate applications and the use of various SCSs to allow very low latency radio transmissions for delay sensitive services. However, the main drawbacks of radio transmission in high frequency bands (i.e., in FR2) are the high attenuation in signal strength over distance from the transmitter (high pathloss) and the communication system is prone to frequency/phase errors due to the short wavelengths. For the NR sidelink system, it is claimed to support FR2 spectrum bands by introducing a phase tracking reference signal (PT-RS) in Release 16. However, no particular enhancement or advanced feature has been supported in NR sidelink to combat/mitigate the high pathloss issue in FR2.

### Transmit Beamforming and Sweeping in Downlink

Over downlink (DL) and uplink (UL) of Uu interface, a concept/feature of transmit beamforming and beam management has been developed and introduced since the beginning of the 5G-NR system in Release 15 to improve received signal strength, enhance cellular DL and UL coverages and minimize radio interference to neighbor cells. In order to enable this transmit beamforming/beam management feature over the Uu interface, particularly in the DL, the concept of beam sweeping is introduced by forming a transmit beam and sweeping the transmit beam across all the directions in space (both horizontal and vertical spatial domains) that a base station (gNB) supports. Once a user equipment (UE) has received all the transmit beams or as many as it could (according to a pre-defined pattern and time interval), the UE selects a best beam and sends a physical random-access channel (PRACH) to the gNB in a RACH occasion that corresponds to the selected best beam. At the base station, gNB determines the selected best beam from the UE according to the received RACH occasion and uses the selected best beam to complete the random-access procedure in order for the UE to connect to the base station. The same selected best beam may be also used for the subsequent data communication between the gNB and the UE until the selected best beam is further updated/switched (e.g., due movement of the UE).

### Necessity of Transmit Beamforming and Beam Management in Sidelink

As mentioned previously, radio communication in high frequency spectrum (i.e., FR2 bands) may suffer from large attenuation in the transmitted signals and propagation loss through the space compared to the lower frequency bands that the cellular system traditionally operates. Besides the PT-RS that can be used by sidelink communicating devices to correct phase errors in the received carrier frequency in FR2 and the maximum device transmit power is limited by a device's power class definition, there is currently no other way to improve the communication range/signal coverage, unless the transmit beamforming and beam management features are also supported for the NR sidelink technology. By improving the signal coverage/communication range for sidelink, it may enable a few new use cases and applications for the users and mobile operators, such as enhancing the network coverage from sidelink relaying on a FR2 carrier and offloading network traffic onto a sidelink FR2 carrier for two UEs that are within the same cell.

### Channel Sensing and Reservation in Sidelink Resource Allocation

In 3GPP developed sidelink technology for D 2D communication, transmission resources often need to be selected by a UE itself as a network serving base station is unlikely to have any knowledge of the radio resource usage that is experienced/seen at the UE. Or simply the UE is operating sidelink out of the coverage of any network. To enable a such operation, a UE autonomous resource allocation mode (i.e., Mode 2) is supported in NR sidelink communication. When a sidelink UE operates in Mode 2 resource allocation (RA), the UE is required to perform channel sensing over a time period and decode all received sidelink control information (SCI) that contains reservation information of radio resources from other UEs. Then based on the resource reservation information obtained from channel sensing, the sidelink UE would be able to determine the remaining radio resources that are available for selection and transmission of sidelink data.

However, if the beamforming feature is to be introduced in sidelink communication, the beam direction in which the channel sensing should be performed remains unclear and it would have a significant impact to the results of the channel sensing, the obtained resource reservation information, and the reception performance of sidelink data.

Missed detection of data and signaling messages transmitted in a SL resource pool may occur when TX/RX beamforming operations are applied and different TX/RX beams are used for different SL communication cast types (broadcast, groupcast, unicast). For example, when TX beamforming is used for SL unicast communication and a spatial TX beam direction is applied in a SL transmission by a UE, another UE that does not applied a corresponding RX beam direction for reception would likely to mis-detect the transmitted SL data and signaling messages from the UE. In another example, when a spatial RX beam direction is applied by the UE for reception of SL unicast transmissions in a slot and the another UE transmits broadcast/groupcast data and signaling messages from a different spatial direction, it is likely for the UE to mis-detect the broadcast/groupcast transmitted by the another UE. Furthermore, when the mis-detection of SL signaling message (including resource reservation information) occurs for a UE, transmission collisions between UEs that applies different TX/RX beamforming in different SL communication cast types may be increased due to selection of the same SL resources that comes from no avoidance of reserved resources.

In some embodiments, in the present proposed resource allocation methods for sidelink communication using TX/RX beamforming operation, SL resources are separated/partitioned according to SL communication cast types in a time division multiplexing (TDM) manner such that the TX/RX beamforming operation is applied in time slots/regions only when needed and TX/RX beamforming operation is not used in other time slots/regions to maximize or increase UE reception of SL data and signaling messages of all SL communication cast types. Furthermore, the proposed new resource allocation methods can be used in conjunction with flexible RX beam and inter-UE coordination (IUC) schemes to resolve the issue of not being able to apply different RX beamforming/beams in the same slot to receive multiple SL unicast transmissions from different unicast peer UEs. Other benefits from adopting the proposed resource allocation methods for sidelink communication using TX/RX beamforming operation may also include one or more of the followings: 1. Improved channel sensing results and outcome that includes sidelink resources reserved by UEs other than sidelink unicast communication. And hence, transmission collisions in SL resource pool are minimized. 2. Improved SL data and signaling message reception in SL unicast communication, due to indication of preferred, non-preferred and conflict resources between the pair of unicast UEs.

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

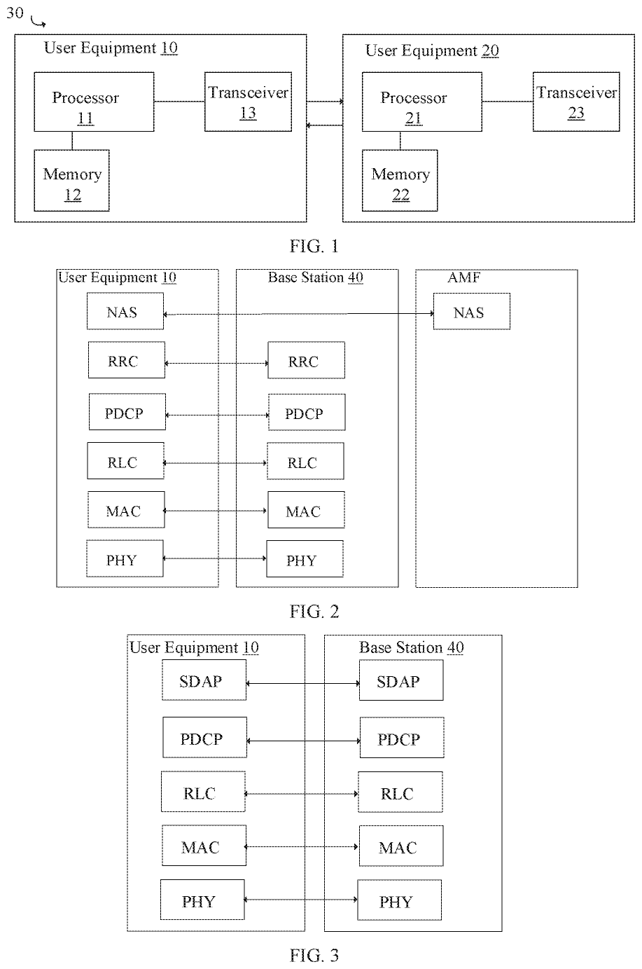

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, the processor 11 is configured to allocate at least one slot for at least one SL communication cast type within at least one resource pool and apply a transmit (TX) beam to transmit or a receive (RX) beam to receive a SL transport block (TB) when the UE 10 operates in the at least one slot for the at least one SL communication cast type. This can solve issues in the prior art and other others, increase UE reception of SL data and signaling messages of all SL communication cast types, and/or improve SL communication performance and reliability.

FIG. 4 illustrates a method 410 of resource allocation in sidelink (SL) communication between user equipments (UEs) according to an embodiment of the present disclosure. In some embodiments, the method 410 includes: an operation 412, allocating at least one slot for at least one SL communication cast type within at least one resource pool, and an operation 414, applying a transmit (TX) beam to transmit or a receive (RX) beam to receive a SL transport block (TB) when the UE operates in the at least one slot for the at least one SL communication cast type. This can solve issues in the prior art and other others, increase UE reception of SL data and signaling messages of all SL communication cast types, and/or improve SL communication performance and reliability.

In some embodiments, the at least one resource pool is dedicated to the at least one SL communication cast type via a first signaling. In some embodiments, the at least one resource pool dedicated to the at least one SL communication cast type is common to at least another UE. In some embodiments, if the at least one resource pool is allocated for SL broadcast communication and/or SL groupcast communication, the UE applies at least one omnidirectional TX beam to transmit or at least one omnidirectional RX beam to receive the SL TB to or from at least another UE operating in the same resource pool as the UE. In some embodiments, if the at least one resource pool is allocated for SL unicast communication, the UE applies at least one unidirectional TX beam to transmit or at least one unidirectional RX beam to receive the SL TB to or from another UE operating in the same resource pool as the UE.

In some embodiments, the at least one resource pool is partitioned into at least one sub-pool or time portion, and the at least one sub-pool or time portion is dedicated to the at least one SL communication cast type via a first signaling. In some embodiments, the at least one sub-pool or time portion dedicated to the at least one SL communication cast type is common to at least another UE. In some embodiments, if the at least one sub-pool or time portion is allocated for SL broadcast communication and/or SL groupcast communication, the UE applies at least one omnidirectional TX beam to transmit or at least one omnidirectional RX beam to receive the SL TB to or from at least another UE operating in the same sub-pool or time portion as the UE. In some embodiments, if the at least one sub-pool or time portion is allocated for SL unicast communication, the UE applies at least one unidirectional TX beam to transmit or at least one unidirectional RX beam to receive the SL TB to or from another UE operating in the same sub-pool or time portion as the UE.

In some embodiments, the at least one slot in time domain with a inclusion of a group of sub-channels in frequency domain within the at least one resource pool is further configured via a first signaling to be the at least one sub-pool or time portion for SL broadcast communication and/or SL groupcast communication. In some embodiments, the first signaling is a common signaling. In some embodiments, the common signaling includes a radio resource control (RRC), a downlink control information (DCI), or a sidelink control information (SCI). In some embodiments, the at least one slot is dedicated to the at least one SL communication cast type via a second signaling. In some embodiments, the resource pool is a common resource pool. In some embodiments, the second signaling is a dedicated signaling, and the dedicated signaling includes a SCI, a medium access control-control element (MAC-CE), or an RRC over a PC5 interface (PC5-RRC).

In some embodiments, if the at least one slot is allocated for SL unicast communication, the UE applies at least one unidirectional TX beam to transmit or at least one unidirectional RX beam to receive the SL TB to or from another UE operating in the same slot as the UE. In some embodiments, the at least one slot allocated for SL unicast communication is further used by the UE to transmit or receive the SL TB for SL broadcast communication and/or SL groupcast communication when not transmitting or receiving the SL TB for SL unicast communication. In some embodiments, the at least one slot for the UE is the same or different from at least another slot for another UE. In some embodiments, the UE applies no RX beam to receive multiple unicast transmissions. In some embodiments, the UE applies a RX beam to cover directions of multiple unicast transmissions. In some embodiments, the UE uses an inter-UE coordination (IUC) and provides a set of preferred resources, a set of non-preferred resources, or a resource conflict indication to at least another UE to avoid reception of multiple unicast transmissions in a same slot.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

In the usage of transmit (TX) beamforming, as described earlier, radiated transmission power of a radio wave is focused in one particular horizontal and/or vertical spatial direction, ideally towards an intended target communicating UE, to enhance radio signal energy arrived at the receiver (after the propagation loss over the space). This special radio transmission technique is commonly known as TX beamforming in the 5th generation new radio (5G NR) mobile communication system, and typically used by a gNB basestation to boost its data transmission power towards the serving UEs. And hence, the decoding performance at the receiver UE can be improved. Similarly, a receive (RX) beamforming can be also applied at the receiver UE to further enhance the signal reception power for the decoder by adjusting the spatial direction in which the receive antenna gain should be applied.

In SL communication, resource pools are typically configured to UEs based on the intended use cases and service requirements, such as latency and reliability targets of the data packet delivery, vehicle-to-vehicle (V2V)/vehicle-to-infrastructure (V2I)/vehicle-to-pedestrian (V2P) services, in-network or out-of-network coverages, and SL resource allocation methods (random, full sensing, partial sensing). Often within a same SL resource pool, different SL transmission cast types (i.e., broadcast/groupcast/unicast) are supported and used by different SL communicating UEs to exchange data messages for the same services.

When TX beamforming and RX beamforming are applied in SL communication, signal transmission and reception directions may greatly affect the channel sensing operation and its results that are needed and used for SL resource selection in a UE autonomous resource allocation mode (e.g., SL RA mode 2), since the transmission and reception are concentrated in one particular spatial direction. Subsequently, the TX and RX beamforming would also significantly influence the communication performance between two SL UEs. For example, when a UE performs RX beamforming and receives SL signals and resource reservation information in one spatial direction, the UE would obtain channel sensing results only in that particular spatial direction and not gain any knowledge in all other directions. This may result in a situation where the UE interprets the channel is quiet and there are many empty resources that are not to be used by others, and hence, available for the UE autonomous resource selection. In fact, due to RX reception for channel sensing is performed in only one direction, many of these available candidate resources may have been selected and reserved by others for their future transmissions. When some of these resources are selected and used by the UE for SL transmission, it creates TX collisions/conflicts with others and causes all conflicted transmissions by the UE and others to fail in the SL system.

In SL broadcast and groupcast communications, as there are multiple and potentially many communicating target/intended transmitters and receivers, TX beamforming and RX beamforming may not work efficiently for these cast types and potentially the application of TX/RX beamforming can be resource wasteful. Therefore, the support of TX beamforming and RX beamforming operations is likely to be restricted to only SL unicast communication. If SL broadcast/groupcast and unicast transmissions are multiplexed in a same resource pool and in a same slot, and RX beamforming is applied for receiving the unicast messages/signals, it is likely the broadcast/groupcast messages/signals in the same slot may not be receivable for the unicast receiver UE. As such, this creates a problem for the unicast UE to receive data and resource reservation messages/information from broadcast/groupcast UEs, and increases the collision probability in the subsequent broadcast/groupcast and unicast transmissions (due to lack of resource reservation information, as explained earlier).

Proposed methods of independent and separated/partitioned of SL TX/RX operation based on communication cast type

In order to maximize or increase UE reception of SL data messages and resource reservation information when SL beamforming operation is only supported in unicast communication, in the present disclosure of new NR sidelink operation, in some embodiments, it is proposed to separate or partition SL TX/RX operation among the different communication cast types in a time division multiplexing (TDM) manner, such that the SL beamforming operation with a specific unidirectional beam (e.g., beam pattern) is applied in a certain allocated time resource (e.g., time slot) while omnidirectional beam (e.g., no beamforming) is used in other allocated time resource.

To separate TX/RX beamforming operation for different SL communication cast types, there are 2 different example methods by which the time resource separation/partitioning can be achieved.

### Example Method 1 (A Resource Pool Level Separation/Partitioning Via a Common Signaling)

In example method 1, the separation/partitioning of TX/RX beamforming operation in the time domain for different SL communication cast types is achieved at a resource pool level by allocating/(pre-)configuring either.

### Option 1: A Resource Pool That is Dedicated to One or More SL Communication Cast Types

When a resource pool is allocated/(pre-)configured for a specific SL communication cast type, a UE that is operating in the resource pool for transmitting and receiving SL signals and channels applies a specific beamforming strategy that is appropriate for the resource pool. For example, if the resource pool is allocated/(pre-)configured for SL broadcast and groupcast communications, the UE applies omnidirectional beam for transmitting and receiving SL signals and channels to/from other UEs operating in the same resource pool (i.e., no TX/RX beamforming). Likewise, if the resource pool is allocated/(pre-)configured for SL unicast communication, the UE applies unidirectional beam(s) for transmitting and receiving SL signals and channels to/from other UEs operating in the same resource pool. The specific unidirectional beam(s) for which the UE operating in the unicast pool could be determined based a beam-paring, beam maintenance, or beam recovery procedure.

Option 2: A resource pool that is partitioned into one or more sub-pools or time portions, where a sub-pool or time portion is designated/assigned to a SL communication cast type.

For example, a set of slots in the time domain with a possible inclusion of a group of sub-channels in the frequency domain within a SL resource pool is further (pre-)configured via a common signaling (e.g., radio resource control (RRC), downlink control information (DCI), sidelink control information (SCI)) to be a sub-pool or time portion for SL broadcast and groupcast communications. Within the (pre-)configured sub-pool or time portion for SL broadcast and groupcast, the UE applies omnidirectional beam for transmitting and receiving SL signals and channels to/from other UEs operating in the same sub-pool or time portion (i.e., no TX/RX beamforming). Likewise, if the sub-pool or time portion is allocated/(pre-)configured for SL unicast communication, the UE applies unidirectional beam(s) for transmitting and receiving SL signals and channels to/from other UEs operating in the same sub-pool or time portion. The specific unidirectional beam(s) for which the UE operating in the unicast sub-pool or time portion could be determined based a beam-paring, beam maintenance, or beam recovery procedure.

Note that, in both Option 1 and Option 2 of the example method 1, the allocated/(pre-)configured resource pool (Option 1) and sub-pool or time portion of a resource pool (Option 2) assigned to a specific SL communication cast type(s) is common to all UEs that receive the (pre-)configuration.

However, a main difference between the above Option 1 and Option 2 can be categorized by the “shape” of the resource pool. In Option 1, the frequency resource size (i.e., number of sub-channels) per slot is constant/uniformed for all slots in a resource pool. The “shape” of a resource pool is, therefore, rectangular. On the other hand, the (pre-)configuration of a sub-pool/time portion for a specific SL communication cast type can be limited to certain slots and frequency sub-channels within a resource pool. Subsequently, the remaining time slots and frequency sub-channels within the resource pool for other SL communication cast types would not always be rectangular. As such, the above Option 2 provides a greater flexibility in resource allocation/(pre-)configuration that is tailored to a specific SL communication cast type.

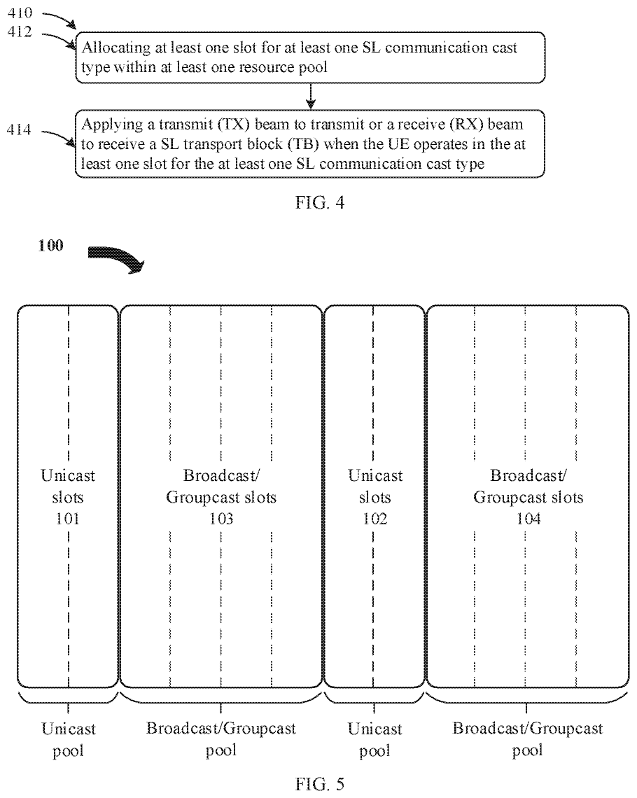

In reference to diagram 100 in FIG. 5, an exemplary illustration of a proposed method for separation of TX/RX beamforming operation for different SL communication cast types in a TDM fashion at a resource pool level is illustrated. By (pre-)configuring a SL resource pool with time slots or time portions dedicated to unicast communication 101 and 102 and multiplexed in time with another (pre-)configured SL resource pool that is dedicated to broadcast and groupcast communications 103 and 104, separation of TX/RX beamforming operation can be achieved for SL communication UEs without any potential mis-detection of broadcast and groupcast data and reservation messages. When a SL UE operates in the unicast slots/resource pool 101 and 102, it can employ a specific TX and RX beam for transmitting its messages to its unicast peer UE and for receiving messages from its unicast peer UE, respectively. When the SL UE operates in the broadcast and groupcast slots/resource pool 103 and 104, the UE does not employ a TX/RX beamforming strategy but to use omnidirectional beam to transmit and receive broadcast and groupcast messages in all directions to/from other UEs.

### Example Method 2 (a Slot Level Separation/Partitioning Via a Dedicated Signaling)

In example method 2, the separation or partitioning of TX/RX beamforming operation in the time domain for different SL communication cast types for two unicast communicating UEs is achieved at a slot level by allocating/configuring a set of time slots or time portions within a SL resource pool that is dedicated for SL unicast communication between the two UEs, where the SL resource pool could be a common resource pool (pre-)configured for all SL communicating UEs. Within the allocated/configured set of time slots or time portions for SL unicast communication between the two UEs, the two UEs apply unidirectional beam(s) for transmitting and receiving SL signals and channels to/from each other. The specific unidirectional beam(s) for which the UEs operating in the unicast time slots could be determined based a beam-paring, beam maintenance, or beam recovery procedure. The allocation/configuration signaling of time slots or time portions for SL unicast between the two UEs within the common SL resource pool could be carried using a dedicated signaling from one UE to the other UE, for example, SCI, medium access control-control element (MAC-CE), or RRC over the PC5 interface (PC5-RRC).

Although SL unicast communication between the two UEs is confined within the allocated/configured time slots or time portions (which are only known by the two unicast UEs), the SL resource pool is common to all other UEs for SL broadcast and groupcast communications, these time slots or time portions should also be used by the two SL unicast communicating UEs when not transmitting or receiving unicast messages for transmitting broadcast and groupcast messages (e.g., using omnidirectional beam without applying TX beamforming) and/or receiving broadcast and groupcast messages (e.g., using unidirectional beam(s) by applying RX beamforming).

Additionally, the set of allocated/configured time slots or time portions from the two SL unicast communicating UEs can be the same or different from each other. That is, when a set of unicast time slots or time portions allocated/configured for SL unicast communication from one UE (first UE) is different from the other UE (second UE), the set of time slots or time portions is meant for SL unicast communication from the first UE and the first UE applies a selected TX beam for its SL unicast transmission to the second UE. The second UE monitors using a selected RX beam in the said set of allocated/configured time slots or time portions for any transmission from the first UE. Similarly, the same allocation/configuration of a set of unicast time slots or time portions and SL operation apply in the other direction for the SL unicast communication as well from the other UE (second UE).

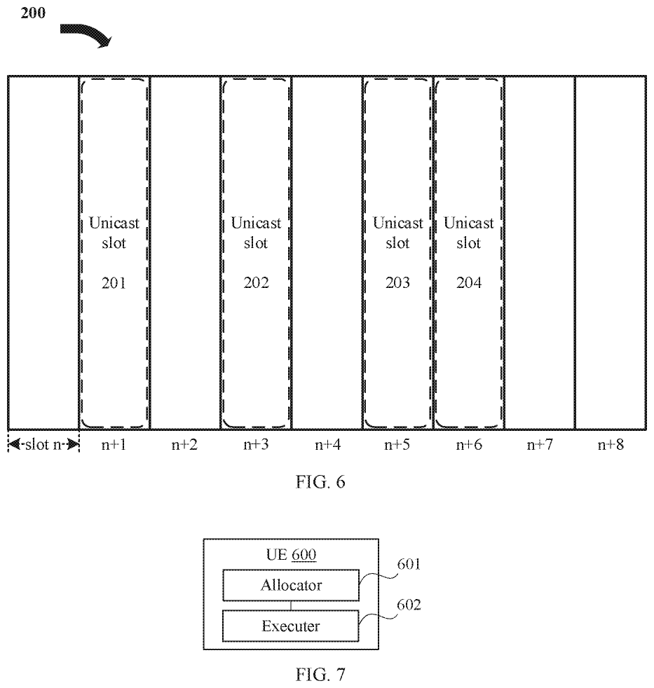

In reference to diagram 200 in FIG. 6, an exemplary illustration of a proposed method for separation of TX/RX beamforming operation for different SL communication cast types at a slot level in a TDM fashion is illustrated. Within a common configured resource pool for all SL communication cast types as illustrated by diagram 200, between a pair of SL UEs having a unicast connection, one UE (a first UE) allocates or configures a set of slots (slot n+1 201, slot n+3 202, slot n+5 203 and slot n+6 204) to its unicast peer UE (a second UE) via SCI, MAC-CE or PC5-RRC for unicast communication. Within the set of unicast slots allocated or configured by the first UE, at least the first UE should use these slots for all SL unicast transmissions to the second UE, and not in other slots of the resource pool. As such, since all SL unicast transmissions from the first UE will be confined within the allocated/configured set of unicast slots, the second UE would apply RX beamforming/beam(s) in these slots for receiving unicast transmissions from the first UE. In all other slots of the resource pool (e.g., slot n, n+2, n+4, n+7 and n+8), the second UE would apply no beamforming for receiving SL broadcast and groupcast transmissions from other UEs. Even within the allocated/configured set of unicast slots from the first UE, the second UE may apply no RX beamforming in a unicast slot that the second UE has not detected a resource reservation for unicast transmission from the first UE to receive SL broadcast and groupcast transmissions from other UEs. Furthermore, when the second UE has detected a resource reservation for a unicast transmission from the first UE and also a resource reservation for a broadcast or groupcast transmission from another UE in the same unicast slot, the second UE may apply no RX beamforming in the said unicast slot if the priority level of the broadcast or groupcast transmission is higher than the unicast transmission from the first UE. By applying no RX beamforming in a unicast slot, it is still possible for the second UE to receive and successfully decode the unicast transmission from the first UE. Note that, the above allocation/configuration of a set of unicast slots from the first UE and the RX beamforming behavior of the second UE in the said set of unicast slots could be also applied to the other direction of the unicast connection.

In one scenario, one SL UE may have multiple SL unicast connections with other UEs and the SL UE detects resource reservations for multiple unicast transmissions in a same slot from different UEs. In this scenario, the SL UE could use one of the following example mitigation solutions to resolve the issue of not being able to apply different RX beamforming/beams in the same slot to receive the multiple unicast transmissions. These example solution A and example solution B can be used in conjunction with any of the above example method 1 and example method 2.

Example solution A: The SL UE applies no RX beamforming to receive the multiple unicast transmissions (e.g., use an omnidirectional beam), or the SL UE applies RX beamforming with a broader beam that would cover the directions of the multiple unicast transmissions from different UEs.

Example solution B: The SL UE uses an inter-UE coordination (IUC) scheme and provides a set of preferred resources, a set of non-preferred resources, or a resource conflict indication to one or more SL unicast peer UEs to avoid the reception of more than one unicast transmission in a same slot.

FIG. 7 illustrates a UE 600 for wireless communication according to an embodiment of the present disclosure. The UE 600 includes an allocator 601 and an executor 602. The allocator 601 is configured to allocate at least one slot for at least one sidelink (SL) communication cast type within at least one resource pool. The executor 602 is configured to apply a transmit (TX) beam to transmit or a receive (RX) beam to receive a SL transport block (TB) when the UE operates in the at least one slot for the at least one SL communication cast type. This can solve issues in the prior art and other others, increase UE reception of SL data and signaling messages of all SL communication cast types, and/or improve SL communication performance and reliability.

In some embodiments, the at least one resource pool is dedicated to the at least one SL communication cast type via a first signaling. In some embodiments, the at least one resource pool dedicated to the at least one SL communication cast type is common to at least another UE. In some embodiments, if the at least one resource pool is allocated for SL broadcast communication and/or SL groupcast communication, the executor 602 applies at least one omnidirectional TX beam to transmit or at least one omnidirectional RX beam to receive the SL TB to or from at least another UE operating in the same resource pool as the UE 600. In some embodiments, if the at least one resource pool is allocated for SL unicast communication, the executor 602 applies at least one unidirectional TX beam to transmit or at least one unidirectional RX beam to receive the SL TB to or from another UE operating in the same resource pool as the UE 600.

In some embodiments, the at least one resource pool is partitioned into at least one sub-pool or time portion, and the at least one sub-pool or time portion is dedicated to the at least one SL communication cast type via a first signaling. In some embodiments, the at least one sub-pool or time portion dedicated to the at least one SL communication cast type is common to at least another UE. In some embodiments, if the at least one sub-pool or time portion is allocated for SL broadcast communication and/or SL groupcast communication, the executor 602 applies at least one omnidirectional TX beam to transmit or at least one omnidirectional RX beam to receive the SL TB to or from at least another UE operating in the same sub-pool or time portion as the UE 600. In some embodiments, if the at least one sub-pool or time portion is allocated for SL unicast communication, the executor 602 applies at least one unidirectional TX beam to transmit or at least one unidirectional RX beam to receive the SL TB to or from another UE operating in the same sub-pool or time portion as the UE 600.

In some embodiments, the at least one slot in time domain with a inclusion of a group of sub-channels in frequency domain within the at least one resource pool is further configured via a first signaling to be the at least one sub-pool or time portion for SL broadcast communication and/or SL groupcast communication. In some embodiments, the first signaling is a common signaling. In some embodiments, the common signaling includes a radio resource control (RRC), a downlink control information (DCI), or a sidelink control information (SCI). In some embodiments, the at least one slot is dedicated to the at least one SL communication cast type via a second signaling. In some embodiments, the resource pool is a common resource pool. In some embodiments, the second signaling is a dedicated signaling, and the dedicated signaling includes a SCI, a medium access control-control element (MAC-CE), or an RRC over a PC5 interface (PC5-RRC).

In some embodiments, if the at least one slot is allocated for SL unicast communication, the executor 602 applies at least one unidirectional TX beam to transmit or at least one unidirectional RX beam to receive the SL TB to or from another UE operating in the same slot as the UE 600. In some embodiments, the at least one slot allocated for SL unicast communication is further used by the executor 602 to transmit or receive the SL TB for SL broadcast communication and/or SL groupcast communication when not transmitting or receiving the SL TB for SL unicast communication. In some embodiments, the at least one slot for the UE 600 is the same or different from at least another slot for another UE. In some embodiments, the executor 602 applies no RX beam to receive multiple unicast transmissions. In some embodiments, the executor 602 applies a RX beam to cover directions of multiple unicast transmissions. In some embodiments, the executor 602 uses an inter-UE coordination (IUC) and provides a set of preferred resources, a set of non-preferred resources, or a resource conflict indication to at least another UE to avoid reception of multiple unicast transmissions in a same slot.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, in order to maximize or increase UE reception of SL data and signaling messages of all SL communication cast types and to avoid transmission collision due to selection of conflict resources when different TX/RX beamforming operation is applied for different cast types, in some embodiments, it is proposed to separate or partition TX/RX beamforming operation among the different communication cast types in a time division multiplexing (TDM) manner, such that the beamforming operation with a specific spatial direction (e.g., beam pattern) is applied in a certain allocated time resource (e.g., time slot) while omnidirectional beam (e.g., no beamforming) is used in other allocated time resources. Further, example method 1 (a resource pool level separation/partitioning via a common signaling) and example method 2 (a slot level separation/partitioning via a dedicated signaling) are disclosed.

Commercial interests for some embodiments are as follows. 1. Solving issues in the prior art and other issues. 2. Increasing UE reception of SL data and signaling messages of all SL communication cast types. 3. Improving a sidelink (SL) communication performance. 4. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

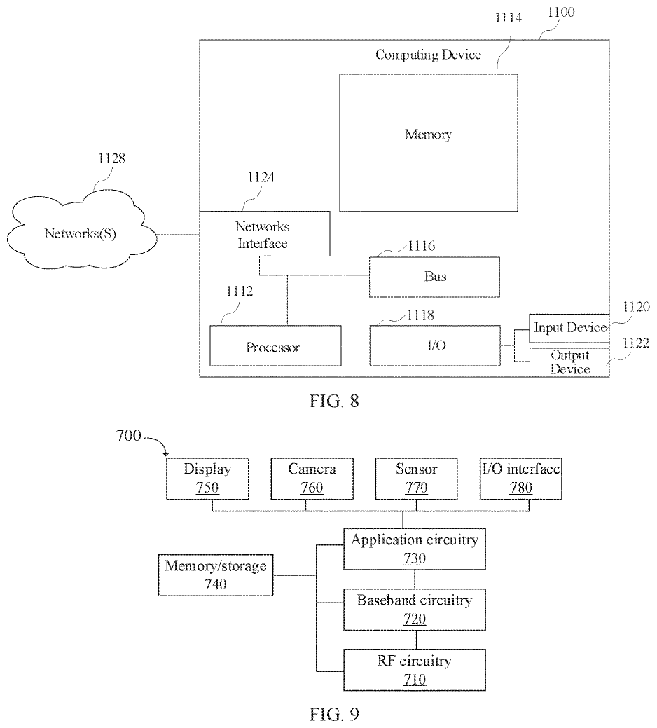

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method of resource allocation in sidelink (SL) communication by a user equipment (UE), comprising:
allocating at least one slot for at least one SL communication cast type within at least one resource pool; and
applying a transmit (TX) beam to transmit or a receive (RX) beam to receive a SL transport block (TB) when the UE operates in the at least one slot for the at least one SL communication cast type.

2. The method of claim 1, wherein the at least one resource pool is dedicated to the at least one SL communication cast type via a first signaling;
wherein the at least one resource pool dedicated to the at least one SL communication cast type is common to at least another UE.

3. The method of claim 1, wherein if the at least one resource pool is allocated for SL broadcast communication and/or SL groupcast communication, the UE applies at least one omnidirectional TX beam to transmit or at least one omnidirectional RX beam to receive the SL TB to or from at least another UE operating in the same resource pool as the UE.

4. The method of claim 1, wherein if the at least one resource pool is allocated for SL unicast communication, the UE applies at least one unidirectional TX beam to transmit or at least one unidirectional RX beam to receive the SL TB to or from another UE operating in the same resource pool as the UE.

5. The method of claim 1, wherein the at least one resource pool is partitioned into at least one sub-pool or time portion, and the at least one sub-pool or time portion is dedicated to the at least one SL communication cast type via a first signaling;
wherein the at least one sub-pool or time portion dedicated to the at least one SL communication cast type is common to at least another UE.

6. The method of claim 2, wherein the first signaling is a common signaling;
wherein the common signaling comprises a radio resource control (RRC), a downlink control information (DCI), or a sidelink control information (SCI).

7. The method of claim 1, wherein the at least one slot is dedicated to the at least one SL communication cast type via a second signaling;
wherein the resource pool is a common resource pool;
wherein the second signaling is a dedicated signaling, and the dedicated signaling comprises a SCI, a medium access control-control element (MAC-CE), or an RRC over a PC5 interface (PC5-RRC).

8. A user equipment (UE), comprising: a memory, a transceiver, and a processor coupled to the memory and the transceiver; wherein the processor is configured to cause the UE to:
allocate at least one slot for at least one sidelink (SL) communication cast type within at least one resource pool; and
apply a transmit (TX) beam to transmit or a receive (RX) beam to receive a SL transport block (TB) when the UE operates in the at least one slot for the at least one SL communication cast type.

9. The UE of claim 8, wherein the at least one resource pool is dedicated to the at least one SL communication cast type via a first signaling;
wherein the at least one resource pool dedicated to the at least one SL communication cast type is common to at least another UE.

10. The UE of claim 8, wherein if the at least one resource pool is allocated for SL broadcast communication and/or SL groupcast communication, the UE applies at least one omnidirectional TX beam to transmit or at least one omnidirectional RX beam to receive the SL TB to or from at least another UE operating in the same resource pool as the UE.

11. The UE of claim 8, wherein the at least one resource pool is partitioned into at least one sub-pool or time portion, and the at least one sub-pool or time portion is dedicated to the at least one SL communication cast type via a first signaling.

12. The UE of claim 11, wherein if the at least one sub-pool or time portion is allocated for SL broadcast communication and/or SL groupcast communication, the UE applies at least one omnidirectional TX beam to transmit or at least one omnidirectional RX beam to receive the SL TB to or from at least another UE operating in the same sub-pool or time portion as the UE;
wherein if the at least one sub-pool or time portion is allocated for SL unicast communication, the UE applies at least one unidirectional TX beam to transmit or at least one unidirectional RX beam to receive the SL TB to or from another UE operating in the same sub-pool or time portion as the UE.

13. The UE of claim 11, wherein the at least one slot in time domain with a inclusion of a group of sub-channels in frequency domain within the at least one resource pool is further configured via a first signaling to be the at least one sub-pool or time portion for SL broadcast communication and/or SL groupcast communication.

14. The UE of claim 8, wherein the at least one slot is dedicated to the at least one SL communication cast type via a second signaling;
wherein if the at least one slot is allocated for SL unicast communication, the UE applies at least one unidirectional TX beam to transmit or at least one unidirectional RX beam to receive the SL TB to or from another UE operating in the same slot as the UE;
wherein the at least one slot allocated for SL unicast communication is further used by the UE to transmit or receive the SL TB for SL broadcast communication and/or SL groupcast communication when not transmitting or receiving the SL TB for SL unicast communication.

15. A non-transitory machine-readable storage medium having stored thereon instructions that, when executed by a computer, cause the computer to:
allocate at least one slot for at least one sidelink (SL) communication cast type within at least one resource pool; and
apply a transmit (TX) beam to transmit or a receive (RX) beam to receive a SL transport block (TB) when the UE operates in the at least one slot for the at least one SL communication cast type.

16. The non-transitory machine-readable storage medium of claim 15, wherein the at least one resource pool is dedicated to the at least one SL communication cast type via a first signaling;
wherein the at least one resource pool dedicated to the at least one SL communication cast type is common to at least another UE.

17. The non-transitory machine-readable storage medium of claim 15, wherein if the at least one resource pool is allocated for SL broadcast communication and/or SL groupcast communication, the UE applies at least one omnidirectional TX beam to transmit or at least one omnidirectional RX beam to receive the SL TB to or from at least another UE operating in the same resource pool as the UE.

18. The non-transitory machine-readable storage medium of claim 15, wherein the at least one slot is dedicated to the at least one SL communication cast type via a second signaling;
wherein the at least one slot for the UE is the same or different from at least another slot for another UE.

19. The non-transitory machine-readable storage medium of claim 15, wherein the UE applies no RX beam to receive multiple unicast transmissions; or
the UE applies a RX beam to cover directions of multiple unicast transmissions.

20. The non-transitory machine-readable storage medium of claim 15, wherein the UE uses an inter-UE coordination (IUC) and provides a set of preferred resources, a set of non-preferred resources, or a resource conflict indication to at least another UE to avoid reception of multiple unicast transmissions in a same slot.
